(19) United States
(12) Patent Application Publication
(10) Pub. No.: US 2008/0259900 A1
(43) Pub. Date: Oct. 23, 2008

(54) MOBILE WIRELESS COMMUNCATION SYSTEM, BASE STATION, MOBILE TERMINAL AND RANDOM ACCESS CONTROL METHOD USED THEREFOR

(76) Inventor: KYOICHIRO MASUDA, Tokyo (JP)

Correspondence Address: NEC CORPORATION OF AMERICA, 6535 N. STATE HWY 161, IRVING, TX, 75039, US

(21) Appl. No.: 11/960,323

(22) Filed: Dec. 19, 2007

(30) Foreign Application Priority Data
Jan. 31, 2007 (JP) 020276/2007

(51) Int. Cl. H04Q 7/00

(52) U.S. Cl. 370/348

(57) ABSTRACT

A base station which, when a communication start request signal is transmitted by a mobile terminal using an access slot and a signature selected at random in the start of random access communication, transmits either a request acknowledgement signal or a request negative acknowledgement signal indicative of permission or rejection on the communication start request to the mobile terminal, the base station including:

an access slot and signature designation part that designates either the access slot or the signature at transmission of the request negative acknowledgement signal to the mobile terminal; and

a request acknowledgement signal transmission part that transmits a request acknowledgement signal to the mobile terminal in priority upon receipt of the communication start request signal transmitted with either the designated access slot or signature from the mobile terminal.

### INCORPORATION BY REFERENCE

This application is based upon and claims the benefit of priority from Japanese patent applications No. 2007-020276, filed on Jan. 31, 2007, the disclosure of which is incorporated herein its entirety by reference.

### BACKGROUND OF THE INVENTION

1. Field of the Invention

The present invention relates to a mobile wireless communication system, a base station, a mobile terminal and a random access control method used therefor and relates, in particular, to a method for improving efficiency and throughput of random access communication in a mobile wireless communication system.

2. Description of the Related Art

In the recent years, data exchanged in a mobile wireless communication cover not only related voice communication but also a wide variety of characters, images, music and video. Data amount thereof are massive. Therefore, efficient use of communication resource of a mobile wireless communication system is desired.

At an occasion of sending the above described data such as characters, images, music and video from a mobile terminal to a base station, the data is generally packeted and sent in a random access communication system. For example, in a W-CDMA (Wideband-Code Division Multiple Access) system, PRACH (Physical Random Access Channel) is prepared as a channel dedicated for random access (for example, see Patent Document 1 (Japanese Patent Application Laid-Open No. 2002-246952) and non-Patent Document 1 (“Physical channels and mapping of transport channels onto physical channels 5.2.2.1 Physical Random Access Channel (PRACH)” (3GPP (3rd Generation Partnership Project) TS25.211 V7.0.0 (2006-03)))).

In the random access communication of a mobile wireless communication system, if a mobile terminal is desired to start the random access communication, a communication start request signal called a preamble is transmitted from the mobile terminal to a base station with a randomly selected access slot and signature.

The base station gets back with a request acknowledgement signal (ACK: acknowledgement) in the case of permitting a communication start request signal of its mobile terminal. In addition, the base station gets back with a request negative acknowledgement signal (NACK: negative acknowledgement) in the case of rejection.

The case where the mobile terminal carries out random access communication as described above is illustrated in FIG. 8. In FIG. 8, in the case of carrying out random access communication, a mobile terminal selects a signature and an access slot at random (steps S21 and S22 in FIG. 8) and transmits a preamble (step S23 in FIG. 8).

Upon reception of a request acknowledgement signal (ACK) from a base station (step S24 in FIG. 8), the mobile terminal transmits a message (step S25 in FIG. 8) to terminate processing.

In addition, upon reception of a request negative acknowledgement signal from the base station (step S26 in FIG. 8), the process returns to the step S21 to reselect a signature and an access slot at random and transmits a preamble again.

On the other hand, when the mobile terminal receives neither a request acknowledgement signal nor a request negative acknowledgement signal from the base station (steps S24 and S26 in FIG. 8) and the number of retransmission of the preamble exceeds a pre-determined range (steps S27 in FIG. 8), the process is terminated.

In that case, if the number of retransmission falls within a pre-determined range (a step S27 in FIG. 8), the mobile terminal increases transmission power (undergoes power ramping) by a constant quantity (a step S28 in FIG. 8), returns to the step S21, reselects a signature and access slot at random and retransmit a preamble.

However, in the PRACH in a related W-CDMA system, a user might be made to wait long until communication starts at the time of trying a start of random access communication at the occasion of a busy network.

In the related art, at the occasion of retransmitting a preamble after a mobile terminal has received a request negative acknowledgement signal, an access slot and a signature are required to be reselected. Therefore, a base station has no knowledge how many times transmission of a preamble has been tried by the mobile terminal.

As a result, a mobile terminal having carried out transmission of a preamble once is treated likewise a mobile terminal having carried out transmission of a preamble a plurality of times and, therefore, receives request negative acknowledgement signals a lot of times continuously. Consequently, a mobile terminal unable to start transmitting a message is likely to come up.

### SUMMARY

Therefore, an exemplary object of the invention is that the above described problems are eliminated to provide a mobile wireless communication system capable of reducing waiting time until a mobile terminal starts random access communication, a base station, a mobile terminal and a random access control method used therefor.

An exemplary aspect of the invention is a base station which, when a communication start request signal is transmitted by a mobile terminal using an access slot and a signature selected at random in the start of random access communication, transmits either a request acknowledgement signal or a request negative acknowledgement signal indicative of permission or rejection on the communication start request to the mobile terminal, the base station including:

an access slot and signature designation part that designates either the access slot or the signature at transmission of the request negative acknowledgement signal to the mobile terminal; and

a request acknowledgement signal transmission part that transmits a request acknowledgement signal to the mobile terminal in priority upon receipt of the communication start request signal transmitted with either the designated access slot or signature from the mobile terminal.

An exemplary aspect of the invention is a mobile terminal transmitting a communication start request signal to a base station using an access slot and a signature selected at random in the start of random access communication and receiving from the base station either the request acknowledgement signal or the request negative acknowledgement signal indicative of permission or rejection on the communication start request, the mobile terminal including:

a communication start request signal retransmission part that retransmits the communication start request signal with either the access slot or the signature designated by the base station upon receipt of the request negative acknowledgement signal.

An exemplary aspect of the invention is a mobile wireless communication system including a mobile terminal that transmits a communication start request signal, to a base station, using an access slot and a signature selected at random in the start of random access communication; and

a base station that transmits, to the mobile terminal either a request acknowledgement signal or a request negative acknowledgement signal indicative of permission or rejection on a communication start request,
wherein the base station includes an access slot and signature designation part that designates either the access slot or the signature at transmission of the request negative acknowledgement signal to the mobile terminal and a request acknowledgement signal transmission part that transmits a request acknowledgement signal to the mobile terminal in priority upon receipt of the communication start request signal transmitted with either the designated access slot or signature from the mobile terminal; and

the mobile terminal includes a communication start request signal retransmission part that retransmits the communication start request signal with either the access slot or the signature designated by the base station upon receipt of the request negative acknowledgement signal.

An exemplary aspect of the invention is a random access control method used for a mobile wireless communication system in which a mobile terminal transmits a communication start request signal to a base station with an access slot and a signature selected at random in the start of random access communication and the base station transmits either a request acknowledgement signal or a request negative acknowledgement signal indicative of permission or rejection on the communication start request to the mobile terminal, the method including:

the base station designating either the access slot or the signature at transmission of the request negative acknowledgement signal to the mobile terminal and transmitting the request acknowledgement signal to the mobile terminal in priority upon receipt of the communication start request signal transmitted from the mobile terminal with either the designated access slot or signature; and
the mobile terminal transmitting the communication start request signal with either the access slot or the signature designated by the base station upon receipt of the request negative acknowledgement signal.

An exemplary aspect of the invention is a recording medium recording a program of a random access control method used for a mobile wireless communication system in which a mobile terminal transmits a communication start request signal to a base station with an access slot and a signature selected at random in the start of random access communication and the base station transmits either a request acknowledgement signal or a request negative acknowledgement signal on the communication start request to the mobile terminal, wherein

the recording medium is provided in the mobile terminal and

the program includes retransmitting the communication start request signal, by a computer inside the mobile terminal, with either the access slot or signature designated by the base station upon receipt of the request negative acknowledgement signal.

An exemplary aspect of the invention is a recording medium recording a program of a random access control method used for a mobile wireless communication system in which a mobile terminal transmits a communication start request signal to a base station with an access slot and a signature selected at random in the start of random access communication and the base station transmits either a request acknowledgement signal or a request negative acknowledgement signal on the communication start request to the mobile terminal, wherein

the recording medium is provided in the base station and

the program includes, by a computer inside the base station, designating either the access slot or the signature at transmission of the request negative acknowledgement signal to the mobile terminal and transmitting a request acknowledgement signal to the mobile terminal in priority upon receipt of the communication start request signal transmitted from the mobile terminal with either the designated access slot or signature.

### BRIEF DESCRIPTION OF THE DRAWINGS

FIG. 1 is a block diagram illustrating a configuration of a first exemplary embodiment of the present invention;

FIG. 2 is a block diagram illustrating a configuration of a second exemplary embodiment of the present invention;

FIGS. 3A and 3B are schematic diagrams illustrating operations of a mobile wireless communication system by a fourth embodiment of the present invention;

FIG. 4 is a block diagram illustrating a configuration of the mobile terminal 1 in FIG. 3;

FIG. 5 is a block diagram illustrating a configuration of the base station 2 in FIG. 3;

FIG. 6 is a flow chart illustrating a process operation of the mobile terminal 1 by the fourth embodiment of the present invention;

FIG. 7 is a flow chart illustrating a process operation of the base station 2 by the fourth embodiment of the present invention; and

FIG. 8 is a flow chart illustrating a process operation of a related mobile terminal.

### EXEMPLARY EMBODIMENT

At first, the gist of the present invention will be described. An exemplary aspect of the invention is that, at the occasion where a base station transmits a request negative acknowledgement signal (NACK: negative acknowledgement) to a mobile terminal, in a mobile wireless communication system of the present invention, the base station concurrently designates a signature number for use for the next time in order to solve the above described problems.

Thereby, by using a designated signature, the mobile terminal having once received the request negative acknowledgement signal will be capable of receiving a request acknowledgement signal (ACK: acknowledgement) in priority at the time of transmitting a preamble for the next time.

An exemplary aspect of the invention is that in a mobile wireless communication system of the present invention, a base station transmits a request negative acknowledgement signal for a communication start request from a mobile terminal at random access communication and, then, concurrently transmits, together with a request negative acknowledgement signal, a signature number for the next use.

In more specific description, an exemplary aspect of the invention is that, in a mobile wireless communication system of the present invention, a mobile terminal transmits a communication start request signal called a preamble to a base station with an access slot and a signature selected at random in the case where random access communication is desired to start.

In the case of permitting a communication start request of the mobile terminal, the base station gets back to the mobile terminal with a request acknowledgement signal. In the case of rejecting the communication start request, the base station gets back to the mobile terminal with a request negative acknowledgement signal and a signature number for the next use.

A signature number designated here is regarded to be reserved for dedicated use of a mobile terminal that has requested start of communication and yet the request has been rejected.

In receipt of a request acknowledgement signal, the mobile terminal starts message transmission. In receipt of a request negative acknowledgement signal, the mobile terminal transmits a preamble again with a signature of the designated number. The base station side gets back to a mobile terminal transmitting a preamble with the designated signature with a request acknowledgement signal in priority.

Thus, an exemplary aspect of the invention is a mobile wireless communication system that can reduce waiting time until a mobile terminal starts random access communication by a base station getting back to the mobile terminal having once received a request negative acknowledgement signal with a request acknowledgement signal in priority.

In addition, an exemplary aspect of the invention is the mobile wireless communication system that can restrain the number of preamble transmission at the occasion where a mobile terminal starts random access communication and, therefore, can save power consumption of the mobile terminal.

Next, exemplary embodiments of the present invention will described with reference to the drawings.

### First Exemplary Embodiment

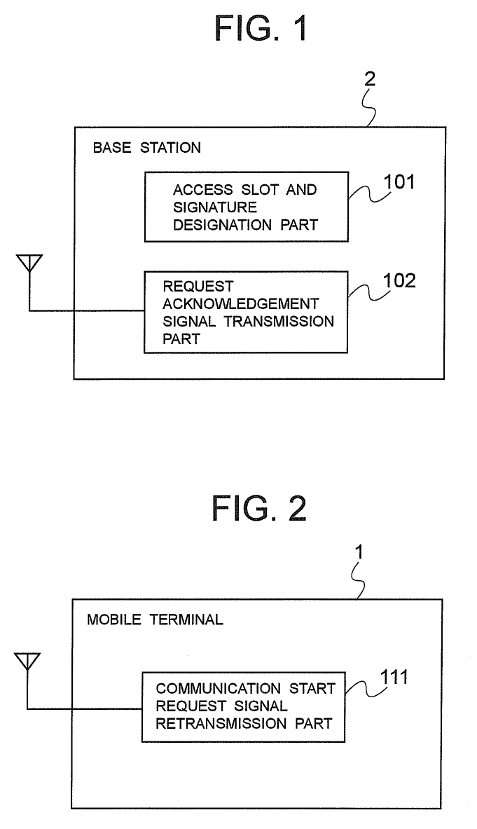

FIG. 1 is a block diagram illustrating a configuration example of a first exemplary embodiment. With reference to the drawing, a base station 2 is configured to include an access slot and signature designation part 101 and a request acknowledgement signal transmission part 102.

That is, a base station which, when a communication start request signal is transmitted by a mobile terminal using an access slot and a signature selected at random in the start of random access communication, transmits either a request acknowledgement signal or a request negative acknowledgement signal indicative of permission or rejection on the communication start request to the mobile terminal, the base station including:

an access slot and signature designation part that designates either the access slot or the signature at transmission of the request negative acknowledgement signal to the mobile terminal; and

a request acknowledgement signal transmission part that transmits a request acknowledgement signal to the mobile terminal in priority upon receipt of the communication start request signal transmitted with either the designated access slot or signature from the mobile terminal.

A first exemplary advantage according to the invention is that waiting time until a mobile terminal starts random access communication can be reduced by a base station getting back to the mobile terminal having once received a request negative acknowledgement signal with a request acknowledgement signal in priority.

### Second Exemplary Embodiment

FIG. 2 is a block diagram illustrating a configuration example of a second exemplary embodiment. With reference to the drawing, the mobile terminal 1 is configured by including a communication start request signal retransmission part 111.

That is, a mobile terminal transmitting a communication start request signal to a base station using an access slot and a signature selected at random in the start of random access communication and receiving from the base station either the request acknowledgement signal or the request negative acknowledgement signal indicative of permission or rejection on the communication start request, the mobile terminal including:

a communication start request signal retransmission part that retransmits the communication start request signal with either the access slot or the signature designated by the base station upon receipt of the request negative acknowledgement signal.

According to a second exemplary advantage according to the invention is that a mobile terminal can restrain the number of preamble transmission at the occasion where the mobile terminal starts random access communication and, therefore, it can be possible to save power consumption of the mobile terminal.

### Third Exemplary Embodiment

A third exemplary embodiment relates to a configuration example of a mobile wireless communication system. The configuration example of the mobile wireless communication system is displayed by incorporating FIG. 1 and FIG. 2 together.

A third exemplary advantage according to the invention is that waiting time until a mobile terminal starts random access communication can be reduced.

### Fourth Exemplary Embodiment

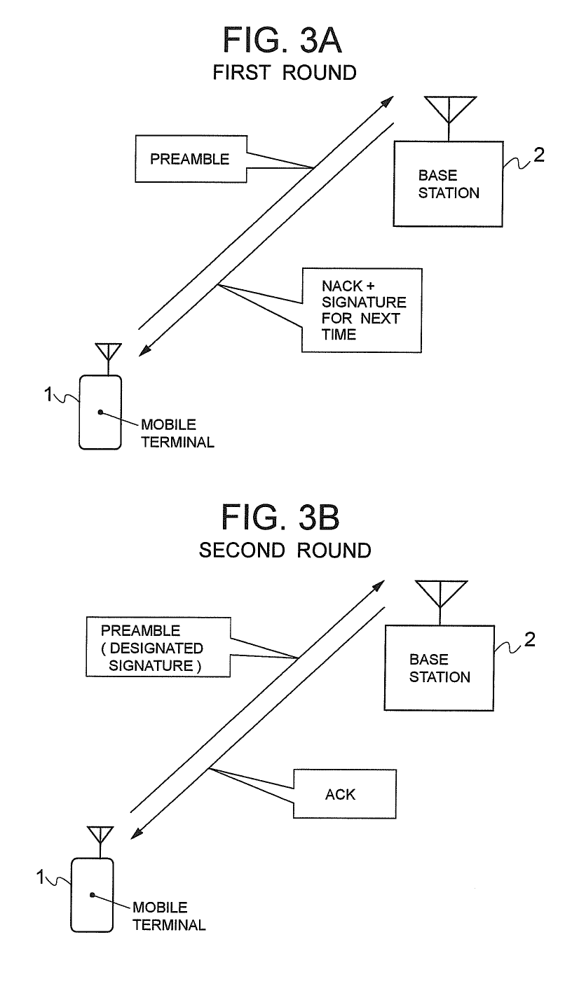

FIGS. 3A and 3B are schematic diagrams illustrating operations of a mobile wireless communication system by a fourth embodiment of the present invention. FIGS. 3A and 3B illustrate an example of the case of applying the fourth embodiment of the present invention to a portable telephone system in a general CDMA (Code Division Multiple Access) system including a mobile terminal 1 and a base station 2.

A mobile terminal 1 transmits a communication start request signal called a preamble to a base station 2 with an access slot and a signature selected at random in the case where random access communication is desired to start.

In the case of rejecting the communication start request of the mobile terminal 1, the base station 2 gets back to the mobile terminal 1 with a request negative acknowledgement signal (NACK: negative acknowledgement) and a signature number for the next use [see a first round in FIG. 3A]. A signature designated here is regarded to be reserved for dedicated use of a mobile terminal 1 that has requested start of communication and yet the request has been rejected.

In receipt of a request negative acknowledgement signal, the mobile terminal 1 transmits a preamble again with a signature of the designated number. The side of the base station 2 gets back to the mobile terminal 1 transmitting a preamble with the designated signature with a request acknowledgement signal (ACK: acknowledgement) in priority [see a second round in FIG. 3B].

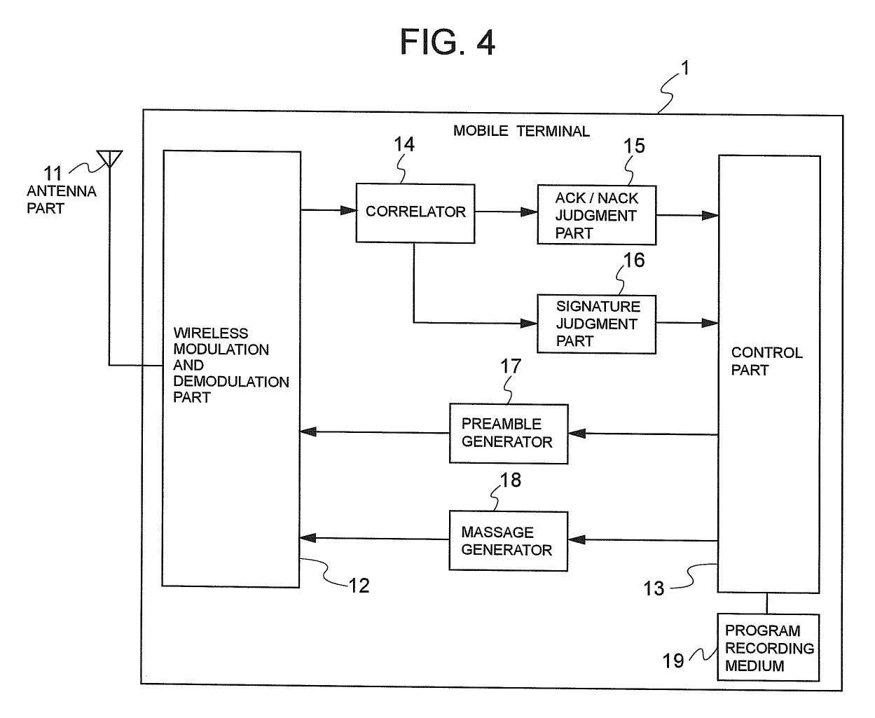

FIG. 4 is a block diagram illustrating a configuration example of the mobile terminal 1 in FIGS. 3A and 3B. In FIG. 4, the mobile terminal 1 is configured by including an antenna part 11, a wireless modulation and demodulation part 12, a control part 13, a correlator 14, an ACK/NACK judgment part 15, a signature judgment part 16, a preamble generator 17, a message generator 18 and a program recording medium 19.

The antenna part 11 and the wireless modulation and demodulation part 12 mutually convert modulated wireless signals and digital signals. The correlator 14 calculates correlation between the signal in reception from the base station 2 and a spread code and returns a result to the ACK/NACK judgment part 15 and the signature judgment part 16.

The ACK/NACK judgment part 15 judges which of the request acknowledgement signal (ACK)/request negative acknowledgement signal (NACK) the signal received from the base station 2 is and transmits a result thereof to the control part 13. The signature judgment part 16 judges the signature number designated by the base station 2 and transmits the judgment result thereof to the control part 13.

The control part 13 controls the preamble generator 17 and the message generator 18 with reference to information from the ACK/NACK judgment part 15 and the signature judgment part 16.

The preamble generator 17 uses the signature designated by the control part 13 to generate a preamble and transmits the signature to the wireless modulation and demodulation part 12 in order to transmit the preamble to the base station 2 with an access slot designated by the control part 13.

The message generator 18 generates a message according to the control part 13 and transmits the message to the wireless modulation and demodulation part 12 in order to transmit the message to the base station 2.

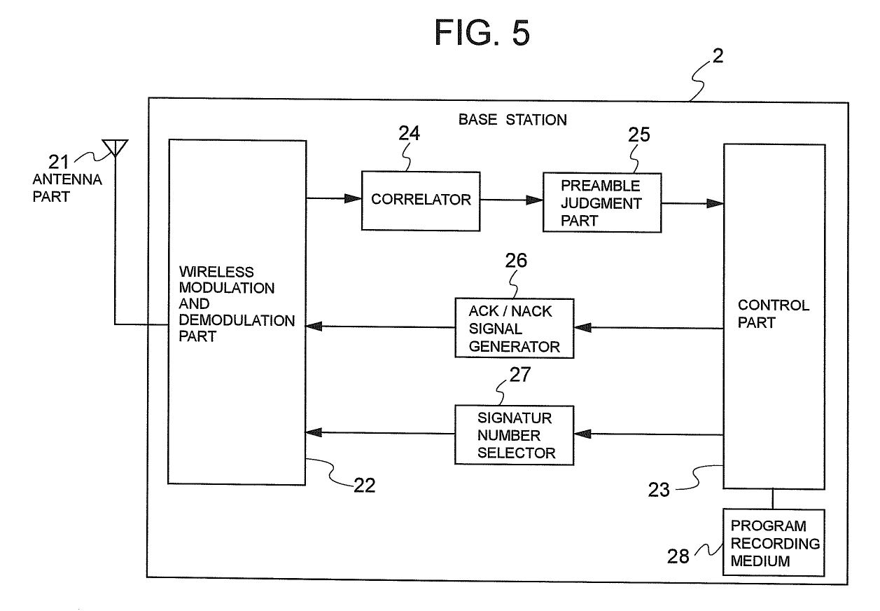

FIG. 5 is a block diagram illustrating a configuration example of the base station 2 in FIGS. 3A and 3B. In FIG. 5, the base station 2 is configured by including an antenna part 21, a wireless modulation and demodulation part 22, a control part 23, a correlator 24, a preamble judgment part 25, an ACK/NACK signal generator 26, a signature number selector 27 and a program recording medium 28.

However, the antenna part 21, the wireless modulation and demodulation part 22 and the correlator 24 act the same role as the above described mobile terminal 1 and, therefore, description thereon will be omitted.

The preamble judgment part 25 judges the signature of the preamble received from the mobile terminal 1 and transmits a judgment result to the control part 23. The control part 23 controls the ACK/NACK signal generator 26 and signature number selector 27 with reference to information from the preamble judgment part 25, a number of the mobile terminal 1 transmitting the random access communication accept request and a state of random access communication of the base station 2.

The ACK/NACK signal generator 26 generates the signal of either the request acknowledgement signal (ACK) and the request negative acknowledgement signal (NACK) designated by the control part 23.

At that time, the request acknowledgement signal (ACK) and the request negative acknowledgement signal (NACK) are generated to correspond to the signature number of the mobile terminal 1.

At the occasion of transmitting the request negative acknowledgement signal (NACK), the signature number selector 27 selects a signature number for a mobile terminal to use for the next time.

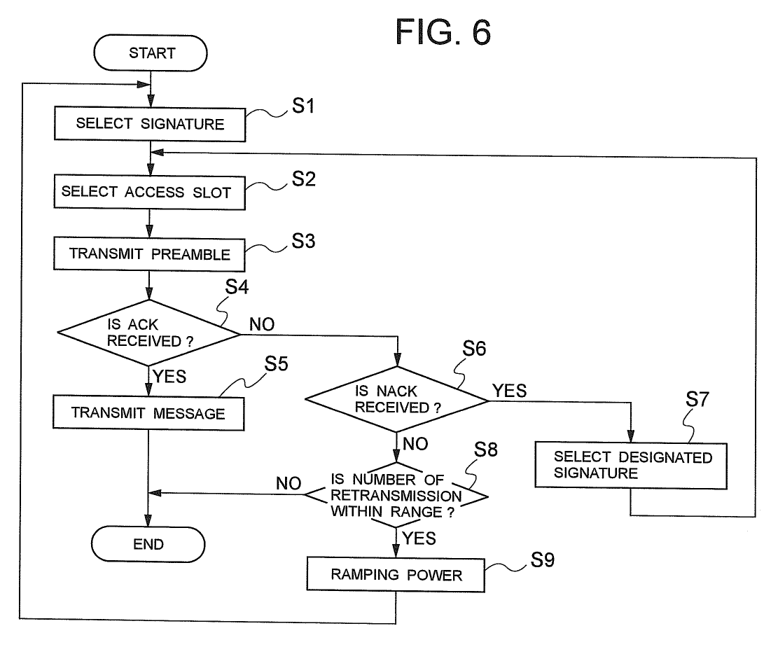

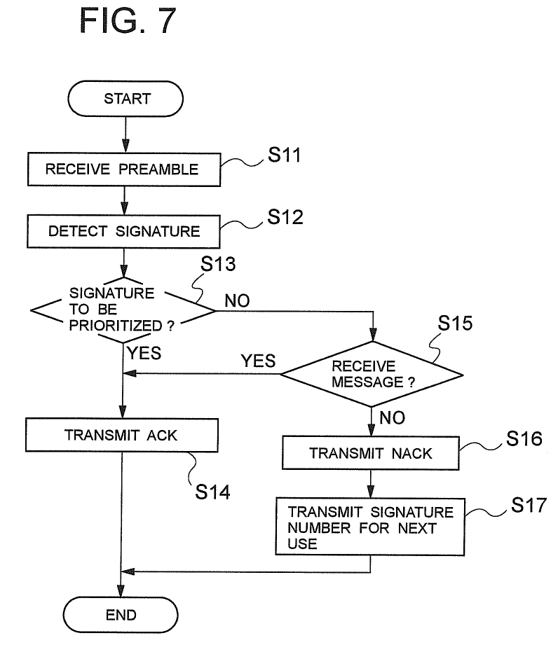

FIG. 6 is a flow chart illustrating a process operation of the mobile terminal 1 by the fourth embodiment of the present invention. FIG. 7 is a flow chart illustrating a process operation of the base station 2 by the fourth embodiment of the present invention. With reference to those FIGS. 3 to FIG. 7, operations of the mobile terminal 1 and the base station 2 will be described.

At first, operations of the mobile terminal 1 will be described with reference to FIG. 6. A program illustrated by the flow chart in FIG. 6 is stored in the program recording medium 19 of the mobile terminal 1. The control part 13 reads a program thereof from that program recording medium 19 to control the respective parts 15 to 18 according to the program thereof.

In order to start random access communication, the mobile terminal 1 selects a signature and an access slot at random at first (steps S1 and S2 in FIG. 6) and transmits a preamble to the base station 2 with the selected signature and access slot (a step S3 in FIG. 6).

In the case of receiving a request acknowledgement signal (ACK) for the transmitted preamble from the base station 2 (a step S4 in FIG. 6), which means that random access communication is permitted, the mobile terminal 1, therefore, subsequently transmits a message (a step S5 in FIG. 6).

On the other hand, in the case of receiving a request negative acknowledgement signal (NACK) for the transmitted preamble (a step S6 in FIG. 6), the mobile terminal 1 uses a signature of a number in receipt concurrently with the request negative acknowledgement signal (NACK) from the base station 2 as a signature (a step S7 in FIG. 6). The mobile terminal 1 uses an access slot selected at random likewise for the first time as the access slot (a step S2 in FIG. 6) to transmit a preamble again (a step S3 in FIG. 6).

In the case of failing reception of neither the request acknowledgement signal (ACK) nor the request negative acknowledgement signal (NACK) from the base station (steps S4 and S6 in FIG. 6), the mobile terminal 1 increases transmission power (undergoes power ramping) by a constant quantity (a step S8 in FIG. 6).

The mobile terminal 1 reselects a signature and an access slot at random (steps S1 and S2 in FIG. 6) and retransmits a preamble (the step S3 in FIG. 6).

However, the number of retransmission of the preamble subjected to power ramping is limited. In the case of exceeding a set retransmission number (a step S8 in FIG. 6), a mobile terminal 1 does not retransmit a preamble but terminates the random access procedure.

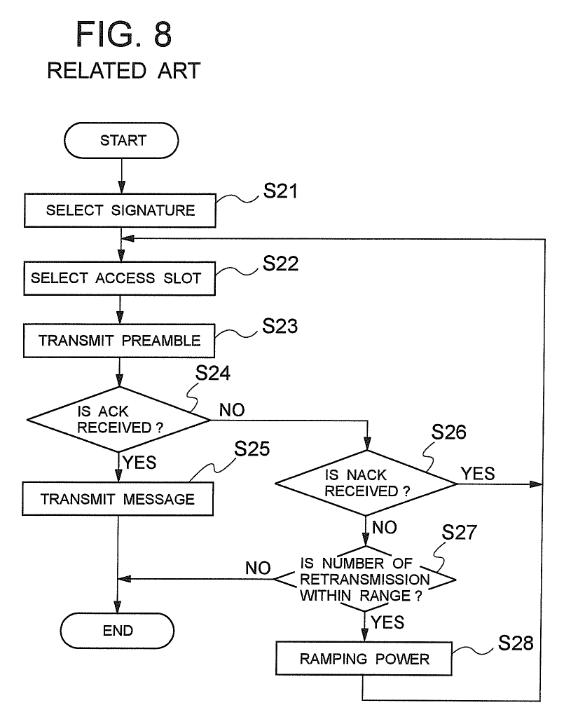

In the case of receiving a request negative acknowledgement signal (NACK) as described above, the fourth embodiment is distinct from process operations of a mobile terminal in a related mobile wireless communication system illustrated in FIG. 8 in the point of using a signature of a number in receipt concurrently with the request negative acknowledgement signal (NACK) from the base station 2 as the signature.

Subsequently, operations of the base station 2 will be described with reference to FIG. 7. A program illustrated by the flow chart in FIG. 7 is stored in the program recording medium 28 of the base station 2. The control part 23 reads a program thereof from that program recording medium 28 to control the respective parts 25 to 27 according to the program thereof.

In receipt of a preamble from the mobile terminal 1 (a step S11 in FIG. 7), the base station 2 judges the signature of the preamble in receipt (a step S12 in FIG. 7).

If the signature in receipt should be replied with a request acknowledgement signal (ACK) in priority (a step S13 in FIG. 7), the base station 2 transmits a request acknowledgement signal (ACK) to the mobile terminal 1 in priority regardless of the state of random access communication of the base station 2 at that time (a step S14 in FIG. 7).

If the signature of the preamble in receipt should not be prioritized (a step S13 in FIG. 7), the base station 2 judges, at that time, which of a request acknowledgement signal (ACK) and a request negative acknowledgement signal (NACK) to transmit with reference to a number of the mobile terminal 1 transmitting the random access communication accept request and a state of random access communication of the base station 2 (a step S15 in FIG. 7).

In the case of transmitting the request negative acknowledgement signal (NACK), the base station 2 concurrently transmits a signature number for the mobile terminal 1 to use at the time of transmitting a preamble again (steps S16 and S17 in FIG. 7).

A designated signature number here is regarded to be selected among reserved ones for dedicated use of the mobile terminal 1 that has requested start of communication and yet the request has been rejected.

In the case where the mobile terminal 1 transmits a preamble with the signature designated here (the step S13 in FIG. 7), the base station 2 thereafter transmits the request acknowledgement signal (ACK) to the mobile terminal 1 in priority (the step S14 in FIG. 7).

Thus, the fourth embodiment can reduce waiting time until the mobile terminal 1 starts random access communication by the base station 2 getting back to the mobile terminal 1 having once received a request negative acknowledgement signal (NACK) with a request acknowledgement signal (ACK) in priority.

In addition, the fourth embodiment can restrain the number of preamble transmission at the occasion where the mobile terminal 1 starts random access communication and, therefore, can save power consumption of the mobile terminal 1.

Here, in the fourth embodiment, the base station 2 transmits a signature number together with the request negative acknowledgement signal (NACK). However, the access slot number can be adopted for the base station 2 to transmit concurrently with the request negative acknowledgement signal (NACK). In that case, it is possible to get back to a mobile terminal 1 having transmitted a preamble with an access slot with a request acknowledgement signal (ACK) in priority.

The fourth exemplary advantage according to the invention is that the above described configuration and operations give rise to such an effect that waiting time until a mobile terminal can start random access communication can be shortened.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A base station which, when a communication start request signal is transmitted by a mobile terminal using an access slot and a signature selected at random in the start of random access communication, transmits either a request acknowledgement signal or a request negative acknowledgement signal indicative of permission or rejection on the communication start request to the mobile terminal, the base station comprising:
an access slot and signature designation part that designates either the access slot or the signature at transmission of the request negative acknowledgement signal to the mobile terminal; and
a request acknowledgement signal transmission part that transmits a request acknowledgement signal to the mobile terminal in priority upon receipt of the communication start request signal transmitted with either the designated access slot or signature from the mobile terminal.

2. The base station according to claim 1, wherein either the access slot or the signature designated to the mobile terminal is reserved for dedicated use of the mobile terminal that has requested start of communication and yet the request has been rejected.

3. The base station according to claim 1, further comprising a signature judgment part that judges either the access slot or the signature in the communication start request signal received from the mobile terminal.

4. A mobile terminal transmitting a communication start request signal to a base station using an access slot and a signature selected at random in the start of random access communication and receiving from the base station either the request acknowledgement signal or the request negative acknowledgement signal indicative of permission or rejection on the communication start request, the mobile terminal comprising:
a communication start request signal retransmission part that retransmits the communication start request signal with either the access slot or the signature designated by the base station upon receipt of the request negative acknowledgement signal.

5. The mobile terminal according to claim 4, wherein either the access slot or the signature designated by the base station is reserved for dedicated use of a mobile terminal that has requested start of communication and yet the request has been rejected.

6. The mobile terminal according to claim 4, further comprising: a request acknowledgement signal judgment part that judges which of the request acknowledgement signal and the request negative acknowledgement signal is transmitted from the base station; and a signature judgment part that judges designation information on either the access slot or the signature.

7. A mobile wireless communication system comprising:
a mobile terminal that transmits a communication start request signal, to a base station, using an access slot and a signature selected at random in the start of random access communication; and
a base station that transmits, to the mobile terminal either a request acknowledgement signal or a request negative acknowledgement signal indicative of permission or rejection on a communication start request,
wherein the base station includes an access slot and signature designation part that designates either the access slot or the signature at transmission of the request negative acknowledgement signal to the mobile terminal and a request acknowledgement signal transmission part that transmits a request acknowledgement signal to the mobile terminal in priority upon receipt of the communication start request signal transmitted with either the designated access slot or signature from the mobile terminal; and
the mobile terminal includes a communication start request signal retransmission part that retransmits the communication start request signal with either the access slot or the signature designated by the base station upon receipt of the request negative acknowledgement signal.

8. The mobile wireless communication system according to claim 7, wherein either the access slot or the signature designated by the base station is reserved for dedicated use of a mobile terminal that has requested start of communication and yet the request has been rejected.

9. The mobile wireless communication system according to claim 7, wherein the mobile terminal includes a request acknowledgement signal judgment part that judges which of the request acknowledgement signal and the request negative acknowledgement signal is transmitted from the base station and a signature judgment part that judges designation information on either the access slot or the signature.

10. The mobile wireless communication system according to claim 7, wherein the base station includes a signature judgment part that judges either the access slot or the signature in the communication start request signal received from the mobile terminal.

11. A random access control method used for a mobile wireless communication system in which a mobile terminal transmits a communication start request signal to a base station with an access slot and a signature selected at random in the start of random access communication and the base station transmits either a request acknowledgement signal or a request negative acknowledgement signal indicative of permission or rejection on the communication start request to the mobile terminal, the method comprising:
the base station designating either the access slot or the signature at transmission of the request negative acknowledgement signal to the mobile terminal and transmitting the request acknowledgement signal to the mobile terminal in priority upon receipt of the communication start request signal transmitted from the mobile terminal with either the designated access slot or signature; and
the mobile terminal transmitting the communication start request signal with either the access slot or the signature designated by the base station upon receipt of the request negative acknowledgement signal.

12. The random access control method according to claim 11, wherein either the access slot or the signature designated by the base station is reserved for dedicated use of the mobile terminal that has requested start of communication and yet the request has been rejected.

13. The random access control method according to claim 11, wherein the mobile terminal carries out judging which of the request acknowledgement signal and the request negative acknowledgement signal is transmitted from the base station and judging designation information on either the access slot or the signature.

14. The random access control method according to claim 11, wherein the base station carries out judging either the access slot or the signature in the communication start request signal received from the mobile terminal.

15. A recording medium recording a program of a random access control method used for a mobile wireless communication system in which a mobile terminal transmits a communication start request signal to a base station with an access slot and a signature selected at random in the start of random access communication and the base station transmits either a request acknowledgement signal or a request negative acknowledgement signal on the communication start request to the mobile terminal, wherein
the recording medium is provided in the mobile terminal and
the program includes retransmitting the communication start request signal, by a computer inside the mobile terminal, with either the access slot or signature designated by the base station upon receipt of the request negative acknowledgement signal.

16. A recording medium recording a program of a random access control method used for a mobile wireless communication system in which a mobile terminal transmits a communication start request signal to a base station with an access slot and a signature selected at random in the start of random access communication and the base station transmits either a request acknowledgement signal or a request negative acknowledgement signal on the communication start request to the mobile terminal, wherein
the recording medium is provided in the base station and
the program includes, by a computer inside the base station, designating either the access slot or the signature at transmission of the request negative acknowledgement signal to the mobile terminal and transmitting a request acknowledgement signal to the mobile terminal in priority upon receipt of the communication start request signal transmitted from the mobile terminal with either the designated access slot or signature.

17. A base station which, when a communication start request signal is transmitted by a mobile terminal using an access slot and a signature selected at random in the start of random access communication, transmits either a request acknowledgement signal or a request negative acknowledgement signal indicative of permission or rejection on the communication start request to the mobile terminal, the base station comprising:
an access slot and signature designation means that designates either the access slot or the signature at transmission of the request negative acknowledgement signal to the mobile terminal; and
a request acknowledgement signal transmission means that transmits a request acknowledgement signal to the mobile terminal in priority upon receipt of the communication start request signal transmitted with either the designated access slot or signature from the mobile terminal.

18. A mobile terminal transmitting a communication start request signal to a base station using an access slot and a signature selected at random in the start of random access communication and receiving from the base station either the request acknowledgement signal or the request negative acknowledgement signal indicative of permission or rejection on the communication start request, the mobile terminal comprising:
a communication start request signal retransmission means that retransmits the communication start request signal with either the access slot or the signature designated by the base station upon receipt of the request negative acknowledgement signal.

19. A mobile wireless communication system comprising:
a mobile terminal that transmits a communication start request signal, to a base station, using an access slot and a signature selected at random in the start of random access communication; and
a base station that transmits, to the mobile terminal either a request acknowledgement signal or a request negative acknowledgement signal indicative of permission or rejection on a communication start request,
wherein the base station includes an access slot and signature designation means that designates either the access slot or the signature at transmission of the request negative acknowledgement signal to the mobile terminal and a request acknowledgement signal transmission means that transmits a request acknowledgement signal to the mobile terminal in priority upon receipt of the communication start request signal transmitted with either the designated access slot or signature from the mobile terminal; and
the mobile terminal includes a communication start request signal retransmission means that retransmits the communication start request signal with either the access slot or the signature designated by the base station upon receipt of the request negative acknowledgement signal.
